(19) United States
(12) Patent Application Publication
(10) Pub. No.: US 2012/0191491 A1
(43) Pub. Date: Jul. 26, 2012

(54) Method and system for providing a public article rental service using a biometric identity card

(75) Inventor: Unho Choi, Seoul (KR)

(73) Assignee: Unho Choi, Seoul (KR)

(21) Appl. No.: 13/440,451

(22) Filed: Apr. 5, 2012

Related U.S. Application Data
(63) Continuation of application No. PCT/KR10/06702, filed on Sep. 30, 2010.

(30) Foreign Application Priority Data
Oct. 8, 2009 (KR) 10 2009 0095871
Dec. 8, 2009 (KR) 10 2009 0120987

(51) Int. Cl. G06Q 10/02; G07B 15/02; G08B 29/00

(52) U.S. Cl. 705/5; 340/5.52; 705/13

(57) ABSTRACT

Disclosed are a method and a system for providing a public facility rental service using a biometric identity card. According to the present invention, an on-site reservation request or an Internet reservation request for a public facility rental service is inputted via an on-site reservation device or via the Internet, an on-site reservation process or an Internet reservation process for the public facility rental service is performed, a request for user identification is inputted, user identification is performed, on-site-reserved or Internet-reserved public facilities are rented out to the authenticated user, and processes for public facility rental fee-charging, returning, theft counteraction, fault counteraction, storage, home delivery and the like are performed through user identification using a biometric identity and a public certificate. Thus, the public facility rental service is provided in a convenient and safe manner through user authentication using a biometric identity.

### CROSS-REFERENCE TO RELATED APPLICATIONS

This application is a continuation of PCT/KR2010/006702 filed Sep. 30, 2010, which claims priority to Korean Patent Application Nos. 10-2009-0095871 filed Oct. 8, 2009, and 10-2009-0120987 filed in Dec. 8, 2009 in Korea, the entire contents of which are incorporated herein by reference.

### TECHNICAL FIELD

The present invention relates to a method and a system for providing a public article rental service using a biometric authentication card, and more particularly to a method and a system for providing a public article rental services using a biometric identity card, which serves rental services using a biometric authentication card which providing user authorization function through a biometric authentication.

### BACKGROUND

The statements in this section merely provide background information related to the present disclosure and may not constitute prior art. Nowadays, many people usually use rental services on public facilities such as bicycles, wheel chairs, laptops, carts, and rides in public places such as a park crowded with many people or in a supermarket, but the user management for renting the public facilities, when serving the rental service, is not effectively managed. Therefore, it may frequently occur the public facilities loss which is never getting back the rented public facilities from corresponding user. Since the user management for the rented public facilities is not managed systematically, there is a growing tendency that the rented users recklessly use the public facilities without the sense of responsibility on the public facilities, thereby it may cause problems in which the public facilities are quickly damaged or gone astray.

### DISCLOSURE

### Technical Problem

Therefore, a preferred embodiment of the present invention provides a method and a system for providing a public facility rental service using a biometric authentication card, which providing a user authorization function through a biometric authentication, thereby reducing the public facilities loss, and preventing the public facilities breakdown by encouraging the sense of responsibility on the public facilities.

The preferred embodiment of the present invention further provide a method and a system for providing a public facility rental service using a biometric authentication card, in which the biometric authentication card has not only a user authorization function through the biometric authentication for the rental service of the public facilities, but also at least one of card functions of a transportation card function and a credit card function.

### Summary

An aspect of the present disclosure provides a system for providing a public facility rental service using a biometric authentication, the system comprises a rental service system for a public facility using a biometric authentication card, the system comprises a reservation processing unit for receiving a field reservation request or Internet reservation request for a public facility rental service through a field reservation unit or Internet, and performing a field reservation process or Internet reservation process; a user authorization section for receiving a user authorization request through a biometric authentication card of a user requested the field reservation request or Internet reservation request and performing the user authorization for the user; and a rental processing unit for performing the public facility rental service reserved through the field reservation or Internet reservation for the authorized user.

Another aspect of the present invention provides a rental service system using a biometric authentication comprises a biometric authentication card for performing the user authorization by authenticating a biometric information; and a device rental terminal for confirming a rental possibility of a public facility by controlling a locking function of a rack upon the user authorization result.

Additional aspect of the present invention provides a rental service method using a biometric authentication comprises a user authorization step of performing a user authorization by authenticating a biometric information in a biometric authentication card; and a rack controlling step, at a device rental terminal, of renting the public facility upon the user authorization result.

### Advantageous Effects

According to the present invention as described above, it has effects of reducing the public facilities loss, and of preventing the public facilities breakdown by encouraging the sense of responsibility on the public facilities, by providing rental services using the biometric authentication card providing user authorization function through the biometric authentication.

Further, according to the preferred embodiment of the present invention, it has effect of using all the rental services, the transportation card function, and the credit card function with only one biometric authentication card without possessing different kinds of cards by providing the biometric authentication card which provides not only the user authorization function through the biometric authorization for the rental service of the public facilities, but also provides at least one of card functions of the transportation card function and the credit card function.

### DESCRIPTION OF DRAWINGS

FIG. 1 is a block diagram showing a rental service system for a public facility using a biometric authentication card according to a preferred embodiment of the present invention.

FIG. 2 is a conceptual diagram schematically showing a rental service system for a public facility using a biometric authentication card according to a preferred embodiment of the present invention.

FIG. 3 is a block diagram showing a rental service system for a public facility using a biometric authentication card according to a preferred embodiment of the present invention.

FIG. 4 is a block diagram showing a biometric authentication card according to a preferred embodiment of the present invention.

FIG. 5 is a flowchart illustrating a rental service method for a public facility using a biometric authentication card according to a preferred embodiment of the present invention.

FIG. 6 is a view prefiguratively illustrating a rental service process of the rental service system for a public facility using a biometric authentication card according to a preferred embodiment of the present invention.

FIG. 7 is a view prefiguratively illustrating a biometric authentication card according to a preferred embodiment of the present invention.

### DETAILED DESCRIPTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

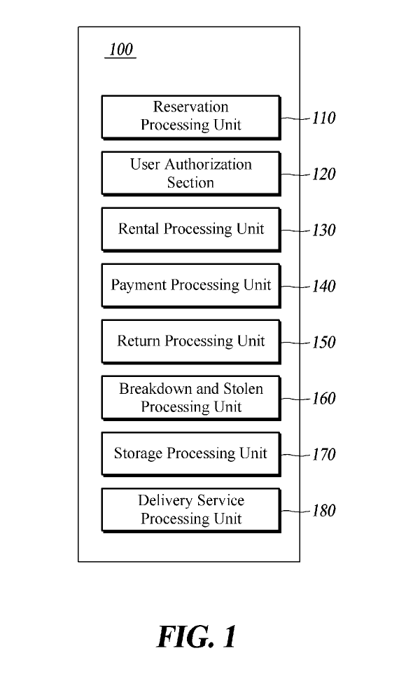

FIG. 1 is a block diagram showing a rental services system 100 for a public facility using a biometric authentication card according to a preferred embodiment of the present invention.

Referring to FIG. 1, the rental services system 100 for the public facility using the biometric authentication card according to the preferred embodiment of the present invention comprises a reservation processing unit 110 for receiving a field reservation request or Internet reservation request for a public facility rental service through a field reservation device or Internet, and performing a field reservation process or Internet reservation process; a user authorization section 120 for receiving a user authorization request through a biometric authentication card of a user requested the field reservation request or Internet reservation request and performing the user authorization for the user; and a rental processing unit 130 for performing the public facility rental service reserved through the field reservation or Internet reservation for the authorized user.

The user authorization section 120, when inputted with the Internet reservation request from the reservation processing unit 110, may perform the user authorization for the user by combining a biometric authorization result through the biometric authentication card with one or more of a public key certificate and an one-time password (OTP). The public key certificate is sort of an electronic guarantee so that a business partner can be trusted when doing business on the web, is issued from the corresponding certificate authority, and comprises a user name of the public key certificate, validity, a public key for confirming digital signature of the user, and a digital signature value of the certificate authority that proves it is a fact.

The biometric authentication card as mentioned above can be implemented as a kind of smart card or a kind of USB security token having USB (Universal Serial Bus) interface.

Referring to FIG. 1, the rental service system 100 for a public facility using a biometric authentication card according to a preferred embodiment of the present invention further comprises a payment processing unit 140 for performing a rental fare payment for the public facility upon the user authorization result.

Referring to FIG. 1, the rental service system 100 for a public facility using a biometric authentication card according to a preferred embodiment of the present invention further comprises one or more of a return processing unit 150 for receiving a field return request or a remote area return request for the public facility through a field return device or Internet, and performing a field return process or a remote area return process for updating a rental related-information of the public facility for the user; a breakdown and stolen processing unit 160 for receiving a breakdown report or stolen report for the public facility through a field receipt device or Internet, and performing a breakdown process or a stolen process for generating and storing a breakdown information and a stolen information for the public facility; a storage processing unit 170 for receiving a storage request for the public facility through the field receipt device or Internet, and performing a storage process for generating and storing a storage information for the public facility; and a delivery service processing unit 180 for receiving a delivery request for the public facility or a personal facility (For example, bicycles, baby carriages, etc.) through the field receipt device or Internet, and requesting for a delivery process of the public facility or the personal facility by generating and storing a delivery request information for the public facilities or the personal facilities.

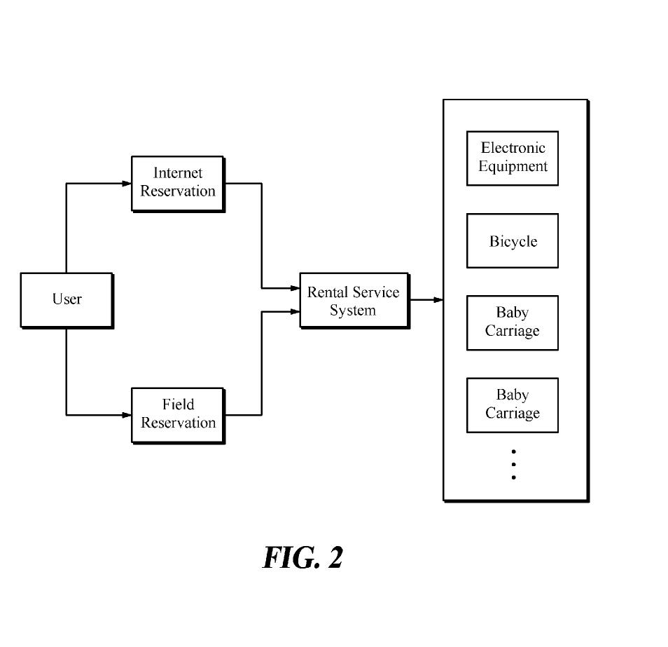

A conceptual diagram, providing the rental service applying the rental service system 100 for the public facility using the biometric authentication card according to a preferred embodiment of the present invention, is prefiguratively illustrated in FIG. 2. Referring to FIG. 2, when provided with the rental service applying the rental service system 100 for the public facility using a biometric authentication card according to a preferred embodiment of the present invention, a user (For example, VIP, the disabled, the older and the weak, children, other requestor.) may make field reservation of the rental services for the public facilities such as multipurpose PDAs, bicycles, baby carriages, wheel chairs or make Internet reservation through Internet from home or office, by using device in which the rental service system 100 is implemented, installed in the rental exits, parking lots, circulation point part. The fare payment upon the field reservation or Internet reservation is, after the user authorization using the biometric authentication card, can be processed as prepaid payment or deferred payment.

The rental service system 100 illustrated prefiguratively in FIG. 1 can be installed, as an example of, in parks, bike lanes, Expos, concert halls, tourist spots, and can be implemented as Kiosk which is a touch screen information transmission system.

Meanwhile, when using the rental service system 100, it is possible to store for certain period of time in certain place, or deliver from a certain place to the other certain place through Internet reservation or the field reservation for not only the public facilities such as bicycles, baby carriages, wheel chairs, electronic devices (For example, laptops, PDAs, etc.) but also the personal facilities such as bicycles, baby carriages, wheel chairs, electronic devices.

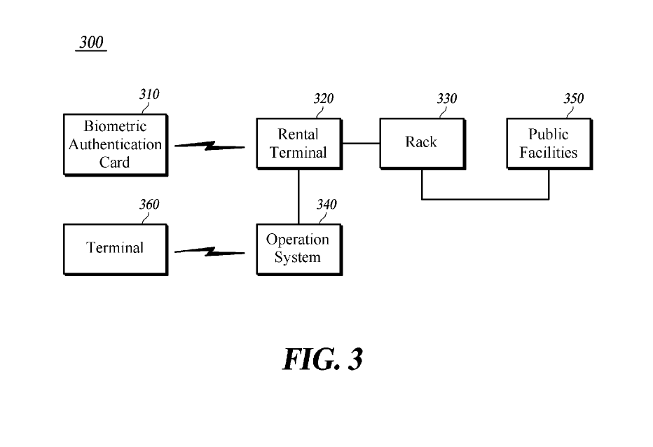

FIG. 3 is a block diagram showing a rental service system for a public facility using a biometric authentication card according to a preferred embodiment of the present invention.

Referring to FIG. 3, the rental service system 100 for the public facility using the biometric authentication card according to the preferred embodiment of the present invention comprises a biometric authentication card 310 for performing the user authorization by authenticating a biometric information; and a device rental terminal 320 for confirming a rental possibility of a public facility 350 by controlling a locking function of a rack 330 upon the user authorization result through a biometric authentication card 310.

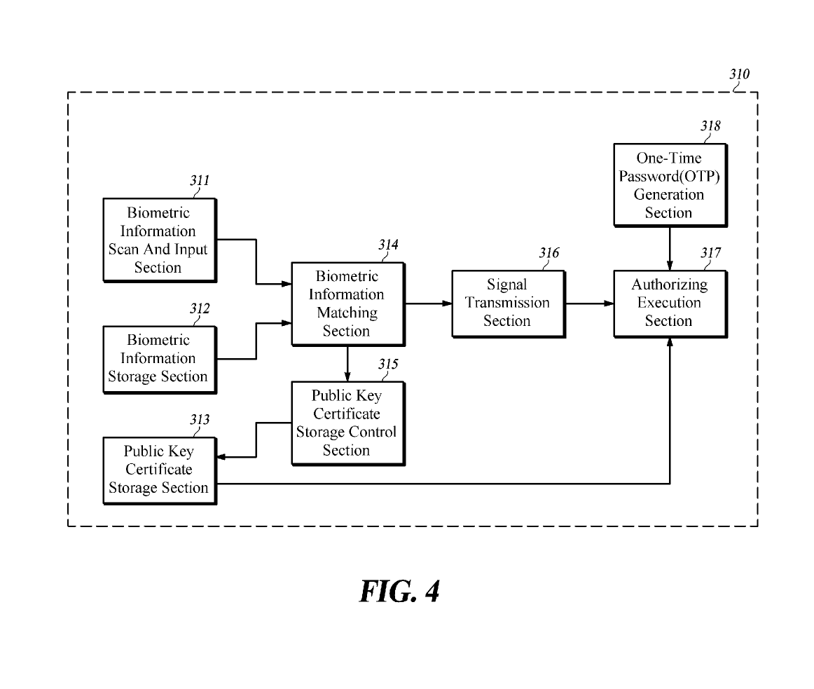

As illustrated in FIG. 4, the biometric authentication card 310 may comprise a biometric information scan and input section 311, a biometric information storage section 312, a public key certificate storage section 313, a biometric information matching section 314, a public key certificate storage control section 315, a signal transmission section 316, an authorizing execution section 317, and an one-time password (OTP) generation section 128.

A rental service provider stores biometric information of a registered subscriber and issues a biometric authentication card 310 matching the stored biometric information. Namely, the biometric authentication card issuance server (not illustrated) of the rental service provider for the public facilities issues, when a client subscribes as a member and registers his or her biometric information to be provided with the rental service for the public facilities, a biometric authentication card 310 by storing the biometric information which matches or is identical to the registered biometric information in the biometric authentication card 310. The biometric information comprises at least one of fingerprint pattern recognition information, vascular pattern recognition information, voice pattern recognition information, iris pattern recognition information, and palm pattern recognition information of the registered subscriber.

The biometric authentication card issuance server can store a public key certificate of a subscriber in the public key certificate storage section 313, and issue the public key certificate. In this case, the biometric authentication card issuance server can not only issue the public key certificate of the subscriber and store it in the public key certificate storage section 313, but also store with the public key certificate of the subscriber which is get issued from the certificate authority and store it in the public key certificate storage section 313. Also, the biometric authentication card issuance server can encode the biometric information of the subscriber and insert the biometric information of the subscriber into the public key certificate which is stored in the public key certificate storage section.

The biometric information scan and input section 311 is inputted with the user biometric information of the biometric authentication card 310. Here, the biometric information scan and input section 311 can be implemented as at least one of a fingerprint recognition sensor, an iris recognition sensor, a voice recognition sensor, a vascular recognition sensor, and a palm recognition sensor.

The biometric information storage section 312 stores the biometric information of the subscriber registered in the biometric authentication card issuance server. In this case, the biometric information storage section 312 stores the biometric information responding to the kind of a sensor of the biometric information scan and input section 311. That is, when the biometric information scan and input section 311 is implemented as fingerprint scan sensor, the biometric information storage section 312 stores the fingerprint pattern recognition information of the registered subscriber as the biometric information, and stores the iris pattern recognition information of the registered subscriber as the biometric information when the biometric information scan and input section 311 is implemented as the iris scan sensor.

The biometric information storage section 312 can store a plurality of biometric information of the registered subscriber. For example, when storing the fingerprint pattern recognition information of the registered subscriber as the biometric information, the fingerprint pattern recognition information of each finger can be stored, and the iris pattern recognition information of both eyes can be stored when storing the iris pattern recognition information of the registered subscriber as the biometric information.

The public key certificate storage section 313 stores the public key certificate which is issued by the public key certificate issuance server 110. In this case, only an organization issuing the biometric authentication card 310 can be implemented to store the public key certificate in the public key certificate storage section 313. Likewise, the user can access the issuance server of the biometric identification card 310 through the network, and store the public key certificate in the public key certificate storage section 313, or take a copy of the public key certificate from a personal computer and store the public key certificate in the public key certificate storage section 313.

The biometric information matching section 314 checks whether the biometric information, which is inputted by the biometric information scan and input section 311, matches the biometric information stored in the biometric information storage section 312. Namely, it is checked whether the biometric information of a smart card user matches the biometric information of the user registered in the public key certificate issuance server.

When the public key certificate storage control section 315 stores a public key certificate in the public key certificate storage section 313, it can be determined whether the information matching the biometric information of the user is included in the public key certificate, only if the biometric information of the user inputted by the biometric information scan and input section 311 matches the biometric information stored in the biometric information storage section 312. Also, the public key certificate storage control section 315 is implemented to store the received public key certificate in the public key certificate storage section 313, only when it is determined that the received public key certificate includes the information matching the biometric information of the user. Therefore, the public key certificate storage control section 315 primarily can allow only the authorized user of the biometric authentication card 310 to store the public key certificate in the public key certificate storage section 313, and the public key certificate stored in the public key certificate storage section 313 secondly can be implemented to limit only to the public key certificate including the information matching the biometric information for the authorized user. But, such public key certificate storage process is to intensify the authorization procedure by the biometric authentication card 310, and in some case, it can be implemented to store the corresponding public key certificate even though it has no information matching the biometric information of the user.

The signal transmission section 316 transmits a tunneling start signal to install a target terminal communication tunnel when it is determined that the biometric information inputted by the biometric information scan and input section 311 matches the biometric information stored in the biometric information storage section 312. Herein, the target terminal can be a device rental terminal 320 which directly connects to the biometric authentication card 310 with a wired or a wireless network, or can be the certain service providing server like an operation system 340 for operating the rental service of the communication terminal which is connected through the network or the public facilities. If the target terminal is the certain service providing server or terminal which is connected through the network, then the location of the target terminal on the network can be set as an URL (Uniform Resource Locator), and the communication tunnel can be installed by establishing a VPN (Virtual Private Network) with the determined URL.

When a plurality of biometric information on the registered subscriber are stored in the biometric information storage section 312, the signal transmission section 316 can be implemented to transmit the tunneling start signal to another target terminal in accordance with the biometric information matching the biometric information inputted through the biometric information scan and input section 311. For example, when the fingerprint pattern recognition information on a plurality of the fingers of the subscriber registered in the biometric information storage section 312 is stored as the biometric information, then the communication tunnel is established as a safety management server such as a police server by one of any fingerprint pattern recognition information, and the emergency signal is transmitted to the server, it is implemented to file a report with the fingerprint pattern recognition information when it is a case for the user to execute the authorization process using the biometric authentication card 310 forcefully by the threat of a stranger.

When the biometric information inputted through the biometric information scan and input section 311 matches the biometric information stored in the biometric information storage section 312, the authorizing execution section 317 processes the user authorization and transmits the result to the device rental terminal 320. Also, the authorizing execution section 317, when the communication tunnel is established to the target terminal by the signal transmission section 316, transmits the authorization information based on the public key certificate stored in the public key certificate storage section 313 to the corresponding target terminal, and processes the authorization that the user of the biometric authentication card 310 is an authorized user.

The OTP generation section 218 generates the OTP in a way determined by the issuance organization of the biometric authentication card 310. In this case, the OTP generated by the OTP generation section 318 is displayed so that the user of the biometric identification card 310 can view, and the authorizing execution section 315 can be implemented to transmit the authorization information to the target terminal after passing through the authorization process on the user of the biometric authentication card 310 one more time through the OTP inputted by the user. Likewise, the OTP generated by the OTP generation section 318 cannot be viewed by the user of the biometric authentication card 310, and the authorizing execution section 317 can combine the OTP generated by the OTP generation section 318 with the authorization information and transmits it to the target terminal, so that it can be implemented to authorize that the corresponding biometric authentication card 310 was issued by the authorized issuance organization.

Such biometric authentication card 310 is not limited to the card kind, but can be implemented as the kind of a dongle, and an USB token, etc.

The device rental terminal 320 as mentioned above, in the state of the public facilities 350 being hold on the rack 330 by the locking device, receives the execution result information (user authorization succeed) which has succeed the user authorization through the biometric authentication card 310, and controls to separate the public facilities 350 from the rack 330 by releasing the locking device.

The biometric authentication card 310 as mentioned above may store the biometric information of a card possessor in the storage media (for example, integrated circuit IC chip, etc), compare the biometric information recognized by the biometric information recognition device with the stored biometric information, execute the user authorization according to the comparison result, and transmit the execution result of the user authorization (user authorization success or failure) to the device rental terminal 320.

The biometric authentication card 310 as mentioned above may recognize one or more of fingerprint pattern recognition information, vascular pattern recognition information, voice pattern recognition information, and iris pattern recognition information as the biometric information through the corresponding biometric information recognition device.

The device rental terminal 320 as mentioned above, when renting the public facilities 350, may comprise a rental fare payment machine for processing the rental fare payment of the public facilities 350 according to the public facility 350 rental by reading the card information from the biometric authentication card 310. The rental fare payment method is a way of paying the certain rental fare in advance before the rental.

The device rental terminal 320 may comprise the rental fare payment machine for reading the card information from the biometric authentication card 310, in rental or return of the public facility 350, calculating the rental time of the public facilities 350 according to the rental and return of the public facilities 350, and processing the rental fare payment of the public facilities 350 based on the calculated rental time. Such rental fare payment method is a way of paying the rental fare differently upon the calculated rental time (from rental time to return time) after the return of the public facility 350.

Meanwhile, as illustrated in FIG. 3, the rental service system 300 for the public facility using the biometric authentication card according to other preferred embodiment of the present invention may further comprise an operation system 340 for storing and managing the rental service information including at least one of a rental information, a return information, and a rental fare information for the public facility by interlinking with the device rental terminal 320, and transmitting a guide message including the rental service information to a user terminal rented the public facility 350.

For example, the user authorization result information included in the rental service information comprises the information on the result (Namely, user authorization success or failure) executing the user authorization by recognizing the biometric information through the biometric authentication card 310. The rental information comprises at least one of rental time, availability of rental, public facility information, and rental place. The return information comprises at least one of return time, whether it is returned or not, public facility information, and return place. The rental fare information comprises at least one of total rental time information, total rental fare, information whether it is paid or not, and payment related information.

The operation system 340 transmits a guide message holding the rental service information which includes at least one of user authorization result information, rental information, return information, and rental fare information to the terminal 360 of the user who is the card owner of the biometric authentication card 310, so the card owner of the biometric authentication card 310 can check the rental service related information used by the owner, and may check whether his or her biometric authentication card 310 is used by other user without his or her permission after the card owner lost his or her biometric authentication card 310.

The biometric authentication card 310 may provide at least one of the card functions of a transportation card function for subway and bus, or a credit card function for the payment at the off-line store such as hospitals or restaurants, or on online shopping mall, besides the user authorization and rental fare when renting public facilities.

A terminal 360 of FIG. 3, as an example of, can be a computer, an IPTV set top box, a CD/ATM, a KIOSK, or a mobile phone which can install or can be installed beforehand with the user authorization device 110. Here, the biometric authentication card 310 is illustrated as it is composed separately from the terminal 360, but it is not limited to that, and the biometric authentication card 310 can combine with the terminal 360 and be implemented as one user authorization device.

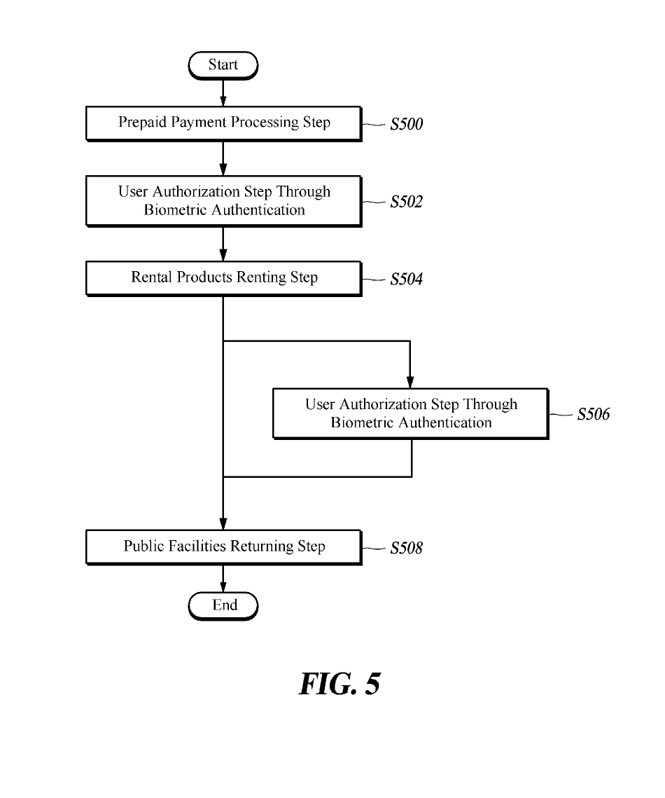

In the rental service system 300 for the public facility using the biometric authentication card according to the other preferred embodiment of the present invention, the public facilities that are rented to the user possessing the biometric authentication card 310 comprise, as an example, at least one of bicycles, wheel chairs, baby carriages, laptops, carts, and rides. The rental service system 300 through the biometric authentication is prefiguratively described referring to FIG. 5.

The FIG. 5 is a flowchart illustrating a rental service method for a public facility using a biometric authentication card according to a preferred embodiment of the present invention. This is a method provided by the rental service 300 for the public facility using the biometric authentication card according to a preferred embodiment of the present invention.

Referring to FIG. 5, the rental service method for the public facility using the biometric authentication card according to a preferred embodiment of the present invention comprises an user authorization step S502 of performing an user authorization by authenticating a biometric information in a biometric authentication card 310; and a public facility rental step S504 of managing the possibility of the public facilities rental by controlling locking function of a rack 330 according to the user authorization execution result by the biometric authentication card 310.

In the public facility rental step S504, when the device rental terminal 320, in the state of the public facilities 350 being hold on the rack 330 by the locking device, receives the execution result information which has succeeded the user authorization through the biometric authentication from the biometric authentication card 310, then controls to separate the public facilities 350 from the rack 330 by releasing the locking device.

Referring to FIG. 5, before the user authorization step S502 through the biometric authentication, the device rental terminal 320 may further comprise a fare prepaid payment processing step S500 processing the payment of the public facility rental fare upon the rental of the public facility by reading a card information from the biometric authentication card in case of renting the public facility. The rental fare payment method through the fare prepaid payment processing step S500 is a way of paying the certain rental fare in advance before renting the public facility.

The flowchart prefiguratively illustrated in FIG. 5, is a flowchart illustrated as assuming the prepaid payment of certain rental fare corresponding to the certain rental time of the certain public facility 350 before the rental of the public facility 350 (For example, before the user authorization step S502 through the biometric authentication). Assuming the case of fare deferred payment of the rental fare upon the rental time calculated based on the rental time and return time after the rented public facility 350 is returned, instead of the prepaid payment processing step S500, the public facility return step S508 of returning the public facility 350 comprises a fare deferred payment processing step of calculating the rental time of the public facility according to the public facility rental and return by reading the card information from the biometric authentication card 310, and processing the payment of the rental fare of the public facility 350 based on the calculated time. This fare payment method is a way of paying the rental fare differently according to the rental time (from rental time to return time) calculated after the public facility 350 is returned.

Meanwhile, the rental service method for the public facility using the biometric authentication card according to a preferred embodiment of the present invention further comprises a guide message transmission step transmitting the guide message including rental fare information which is paid after the fare prepaid payment processing step S500 to the corresponding terminal 360 of the user, or transmitting the guide message including user authorization result information after user authorization step S502 through the biometric authentication to the corresponding terminal 360 of the user, or transmitting the guide message including rental information after the public facility rental step S504 to the corresponding terminal 360 of the user, or transmitting the guide message including return information after the public facility return step S508 to the corresponding terminal 360 of the user, or transmitting the guide message including the state of return and (in fare deferred payment) rental fare information after the public facility return step S306. Also it further comprises return/theft/storage/delivery processing steps S506 such as return process, theft process, storage process, delivery process, besides the return guide message transmission, among the processes until the return of the rental products after renting the rental products.

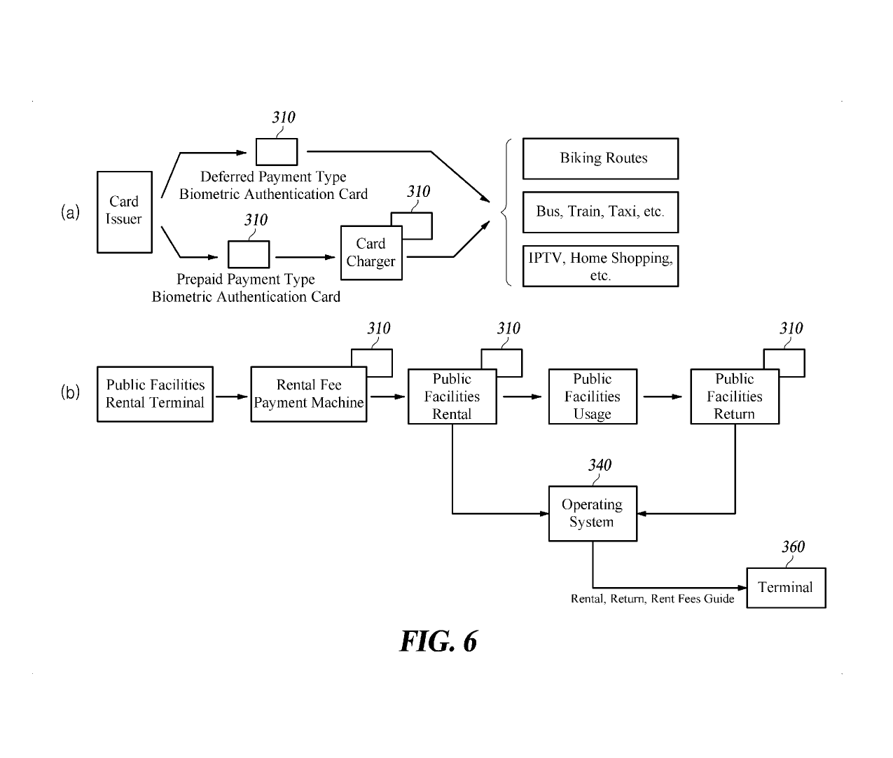

In the rental service method for the public facility using the biometric authentication card according to a preferred embodiment of the present invention, the public facilities that are rented to the user possessing the biometric authentication card 310 comprise, as an example, at least one of bicycles, wheel chairs, laptops, carts, and rides. The service on the rental service system 300 for public facility using the biometric authentication card 310 is prefiguratively described with reference to FIG. 6.

FIG. 6a is a view illustrating an example after the issuance of the biometric authentication card 310. Referring to FIG. 6a, the user, can rent bicycle from the bike lane, or use transportation means such as bus, subway, taxi, or use as an user identification and payment means when using IPTV, and home shopping, etc after charging the certain fare through the card charging machine in case of the fare prepaid payment type biometric authentication card in case of the fare prepaid payment type biometric authentication card.

FIG. 6b is a view showing a serial of procedure using rental service using the issued biometric authentication card 310. Referring to FIG. 6b, the user goes to the public facilities device rental terminal in which the user can rent the public facility he or she wants in case of paying the fare in advance, and pays the rental fare passing through the user authorization using the biometric authentication card 310 through the rental fare payment machine. The user may use the public facility by renting the public facilities he or she wants, after the user authorization using the biometric authentication card 310. The user can use the rented public facilities, and when the renting time is finished or when the user wants to stop using it, then the user can return the public facility through the user authorization with the biometric authentication card 310. Meanwhile, when renting and returning the public facility, the rental service system 300 informs the information such as rental, return, and fare payment to the operation system 340, and the operation system 340 uses SMS message to inform this information or the facts to the terminal 360 such as a mobile phone of the corresponding user.

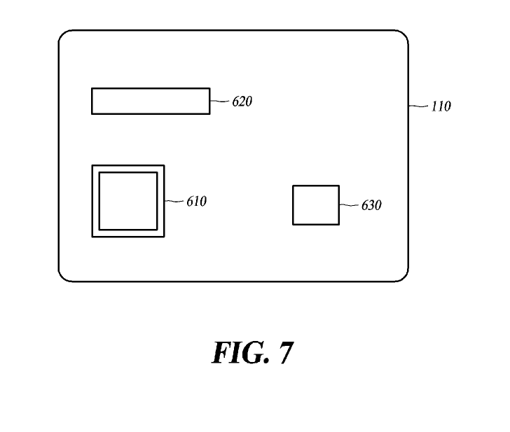

The biometric authentication card 310 as mentioned above description, as prefiguratively illustrated in FIG. 7, comprises a biometric authentication device 610 for recognizing the biometric information such as fingerprint pattern recognition information, a one-time password (OTP) display section 620, and an IC chip 630, and may store the public key infrastructure (PKI) information.

The biometric authentication card 310 may store registered biometric information and all kinds of information in the biometric authentication device 610, IC chip 630, or a storing place within the card to compare with the PKI and authenticated biometric information. Also, the biometric authentication card 310 can be implemented as a kind of the smart card. The OTP and/or the PKI as mentioned above can be used in at least one process of rental, fare payment, return, and storage, delivery of the public facility or personal facility through Internet reservation.

According to the present disclosure as described above, it has effects of reducing the public facilities loss, and of preventing the public facilities breakdown by encouraging the sense of responsibility on the public facilities.

Also, according to the preferred embodiment of the present invention, it has effects of using all the rental services, the transportation card function, and the credit card function with only one biometric authentication card without possessing different kinds of cards by providing the biometric authentication card which provides not only the user authorization function through the biometric authorization for the rental service of the public facilities, but also provides at least one of card functions of the transportation card function and the credit card function.

As above, even though it is explained that all components comprising the preferred embodiment of the present invention are combined or operated after combined, the present invention is not always limited to such preferred embodiment. That is, at least one of those all components can be combined selectively and can be operated. Also, all components can be implemented respectively as an independent hardware, but also it can be implemented as the computer program having program module which performs some or all functions that are combined in one or a plurality of hardware, as some or all of each components are combined selectively. The codes and code segments comprising the computer program can be easily inferred by the person in charge of technical field of the present invention. Such computer program is stored in the computer readable media, and is read and executed by the computer, and can embody the preferred embodiment of the present invention. A magnetic record media, an optical record media, and a carrier wave media are comprised as the computer program storage media.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

1. A rental service system for a public facility using a biometric authentication card, the system comprising:
a reservation processing unit for receiving a field reservation request or Internet reservation request for a public facility rental service through a field reservation unit or Internet, and performing a field reservation process or Internet reservation process;
a user authorization section for receiving a user authorization request through a biometric authentication card of a user requested the field reservation request or Internet reservation request and performing the user authorization for the user; and
a rental processing unit for performing the public facility rental service reserved through the field reservation or Internet reservation for the authorized user.

2. The rental service system according to claim 1, wherein the user authorization section performs the user authorization for the user by combining a biometric authorization result through the biometric authentication card with one or more of a public key certificate and an one-time password.

3. The rental service system according to claim 1, further comprises a payment processing unit for performing a rental fare payment for the public facility upon the user authorization result.

4. The rental service system according to claim 1, further comprising:
a return processing unit for receiving a field return request or a remote area return request for the public facility through a field return unit or Internet, and performing a field return process or a remote area return process for updating a rental related-information of the public facility for the user;
a breakdown and stolen processing unit for receiving a breakdown report or a stolen report for the public facility through a field receipt unit or Internet, and performing a breakdown process or a stolen process for generating and storing a breakdown information and a stolen information for the public facility;
a storage processing unit for receiving for receiving a keep request for the public facility through the field receipt unit or Internet, and performing a keep process for generating and storing a keep information for the public facility; and
a delivery service processing unit for receiving a delivery request for the public facility or a personal facility through the field receipt unit or Internet, and performing a delivery process of the public facility or the personal facility by generating and storing a delivery request information for the public facility or the personal facility.

5. A rental service system for a public facility using a biometric authentication card, the system comprising:
a biometric authentication card for performing the user authorization by authenticating a biometric information; and
a device rental terminal for confirming a rental possibility of a public facility by controlling a locking function of a rack upon the user authorization result.

6. The rental service system according to claim 5, wherein the device rental terminal controls the public facility to depart from the rack by releasing a locking unit, when a result information authorized the user is received from the biometric authentication card in a state that the public facility is placed and locked in the rack by the locking unit.

7. The rental service system according to claim 5, wherein the public facility comprises at least one of a bike, wheel chairs, a baby carriage, a notebook, a cart, and a playing equipment for children.

8. The rental service system according to claim 5, wherein the public biometric authentication card comprising:
a biometric information scan and input section for inputting the biometric information by a user;
a biometric information storage section for storing the biometric information of a registered subscriber;
a biometric information matching section for comparing the biometric information inputted from the biometric information scan and input section with the biometric information stored in the biometric information storage section to determine whether the two biometric information are matched or not; and
an authorizing execution section for authorizing the user when the two biometric information are matched, and transmitting the authorization result to the device rental terminal.

9. The rental service system according to claim 1, wherein the biometric authentication card further comprising:
a public key certificate storage section for storing a public key certificate; and
an public key certificate storage control section for storing the public key certificate in the public key certificate storage section, when both the biometric information inputted from the biometric information scan and input section matches the biometric information stored in the biometric information storage section and a information matched the biometric information for the user is included in the public key certificate.

10. The rental service system according to claim 8, further comprises a signal transmission section for transmitting a tunneling start signal to establish a communication tunnel to a target terminal, when it is determined that the biometric information inputted from the biometric information scan and input section matches the biometric information stored in the biometric information storage section.

11. The rental service system according to claim 5, wherein the biometric authentication card authorizes at least one of fingerprint pattern recognition information, vascular pattern recognition information, palm pattern recognition information, voice pattern recognition information, and iris pattern recognition information as biometric information.

12. The rental service system according to claim 5, wherein the device rental terminal comprises a rental fare payment machine for charging the rental fare of the public facility upon the rental of the public facility by reading a card information from the biometric authentication card in case of renting the public facility.

13. The rental service system according to claim 5, wherein the device rental terminal comprises a rental fare payment machine for calculating rental time of the public facility upon the rental or return of the public facility by reading the card information from the biometric authentication card in case of renting or returning the public facility, and charging the rental fare of the public facility based on the calculated rental time.

14. The rental service system according to claim 5, further comprises an operation system for storing and managing a rental service information including at least one of a rental information, a returning information, and a rental fare information for the public facility by interlinking with the device rental terminal, and transmitting an announcement message including the rental service information to a user terminal rented the public facility.

15. The rental service system according to claim 5, wherein the biometric authentication card provides at least one of a card function from a traffic card function, and a credit card function.

16. A rental service method for a public facility using a biometric authentication card, the method comprising:
a user authorization step of performing a user authorization by authenticating a biometric information in a biometric authentication card; and
a rack controlling step, at a device rental terminal, of renting the public facility upon the user authorization result.

17. The rental service method according to claim 16, wherein the device rental terminal controls the public facility to depart from the rack by releasing a locking unit, when a result information authorized the user is received from the biometric authentication card in a state that the public facility is placed and locked in the rack by the locking unit.
